(19) United States
(12) Patent Application Publication
(10) Pub. No.: US 2003/0147797 A1
(43) Pub. Date: Aug. 7, 2003

(54) Pulse energy transformation

(76) Inventors: Boris Iv. Basok, Kiev (UA); William Begell, New York, NY (US); Anatoliy Dolinsky, Kiev (UA); Georgiy K. Ivanitsky, Kiev (UA); Yelena Shafeyeva, New York, NY (US); Yuliya Shurchkova, Kiev (UA)

Correspondence Address: KENYON & KENYON, 1500 K STREET, N.W., SUITE 700, WASHINGTON, DC, 20005, US

(21) Appl. No.: 10/082,065

(22) Filed: Feb. 26, 2002

Related U.S. Application Data
(60) Provisional application No. 60/271,534, filed on Feb. 26, 2001.

(51) Int. Cl. C01B 35/06

(52) U.S. Cl. 423/293

(57) ABSTRACT

A method and apparatus for providing a substantially homogenous composition from partially immiscible liquids is disclosed where effective energy is applied as pulses of a given frequency to the interface region of an emulsion. The method and apparatus of the invention show substantial savings and efficiency in comparison with conventional methods.

### RELATED DISCLOSURE

The present invention claims the benefit of the filing date of provisional Application No. 60/271,534 filed Feb. 26, 2001, the specification of which is incorporated herein in its entirety.

### BACKGROUND INFORMATION

An emulsion consists of a continuous phase and a disperse phase. For example, in an oil-in-water emulsion such as milk, water is the continuous phase and oil (lipid) is the discrete phase. On the other hand, in a water-in-oil emulsion, such as butter, lipid is the continuous phase and the unbroken fat and water particles are the disperse phase.

The mixing of two or more immiscible liquids to form an emulsion has proved difficult if not impossible in some circumstances. Conventional industrial mixers/emulsifiers have been proposed to provide an emulsion from the raw material. However, in due time, the emulsion often separates to the original phases. In a mixture of oil and water, for example, long periods of the storage causes the emulsion to separate into its original phases. Because oil is heavier that water, the water phase rises to the top and the oil phase settles as the lower layer. In addition, mechanical mixer/emulsifiers have the shortcoming of requiring the expenditure of a great deal mechanical energy to combine the immiscible raw material into an emulsion. As will be discussed, this is due to exertion of energy to the entire composition resulting ineffective use of energy. Aside from the cost of producing the required energy, the energy exerted to the raw material can have adverse effects. For example, in a polymeric reaction emulsifier's energy can cause undesirable side reactions.

To prevent phase separation and to provide a more stable mixture of the immiscible starting material, an surfactant (also known as an emulsifier) is often used. Surfactants usually consist of various oils and oil additives, for which the characteristic linear dimension can be represented by the length of the molecule. A type of conventional surfactants are polymers which can subdivided to natural or synthetic. Synthetic polymer surfactants have a length of 40 to 50 nonometers. while natural surfactants have a length of 50-60 nonometers. However, even with the addition of emulsifiers, phase separation is still possible. Further, the emulsifier itself may introduce undesirable impurities in some applications. Accordingly, there is a need for a more efficient and effective mixing technology.

### SUMMARY OF THE INVENTION

In one embodiment, the present invention is directed to a method for processing a substantially heterogeneous composition to a substantially homogeneous solution by providing a heterogeneous medium having a interface region and applying energy to the interface region of the heterogeneous medium.

### BRIEF DESCRIPTION OF THE DRAWINGS

FIG. 1, schematically illustrates interface between to immiscible components;

FIG. 2. Dynamics of the bubble radius and of the radial velocity of the liquid at the phase interface;

FIG. 3. Dynamics of the bubble radius and of the radial acceleration of the liquid at the phase interface;

FIG. 4. Dynamics of vapor temperature within a collapsing bubble;

FIG. 5. Dynamics of liquid pressure at the phase interface for a collapsing bubble;

FIG. 6. Specific kinetic energy of the liquid at the phase interface in the course of bubble collapse;

FIG. 7. Specific power of energy transformation at the phase interface in the course of bubble collapse;

FIG. 8. The potential energy of interacting molecules.

### DETAILED DESCRIPTION

The instant invention operates on the basis of discrete pulse energy transformation known as the pulse energy transfer (“PET”). This principle is applicable to a large class of physical phenomena and industrial application.

The principal resistance to energy, mass and momentum transfer in a heterogeneous media occurs at the boundary layer or the interface layer of the phase surface.

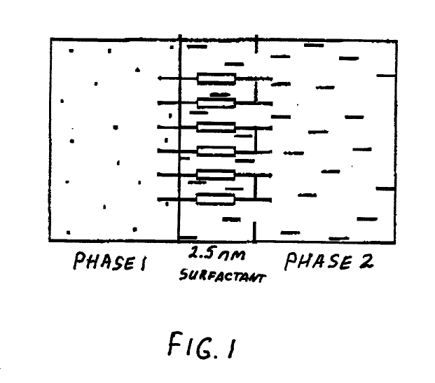

FIG. 1, schematically shows interface region between to immiscible components. The immiscible components of FIG. 1 can be liquid-vapor or liquid-liquid. The liquid-gas (vapor) interface or interface between two mutually immiscible liquids consists of a simple or general successible surfactant layers. This layer stabilizes the interface surface thereby stabilizing the self-organization of the disperse structure of the heterogeneous system. Generally, the surfactant molecules exhibit a branched out, multi-radical structure. However, since their force interaction results in the formation of at least a single monolayer oriented along the molecule perpendicular to the phase interface. In natural systems, for example the emulsion of natural milk, the structure of the surfactant layer at the inter-phase between the fat globule and the milk plasma (a water analog) consists in a sequence of three monolayers of different milk proteins that closely adjoin one another. This complex and branched structure of the surface of the fat globule of a milk emulsion makes it extremely elastic and strong, hence stable to deformation and fragmentation (i.e. emulsification and homogenization). This feature is also responsible for difficulties encountered in designing a homogenizing equipment.

The presence of the surfactant layer is confirmed by the principle of minimum surface energy:

E=σ·S (1)

Where E is the surface energy, σ is the surface tension and S is the surface area of the particle. Thus, either S approaches minimum or σ, in order to bring about self-organization of the phase/inter-phase in the shape of a sphere (at a priori equal volumes) or the reduction of surface tension by means of various factors, in particular, but addition of chemical surfactants, imposition of fields—thermal, electrical, magnetic, electromagnetic, etc. or introduction of chemical additives. This, the addition of a microscopic quantity of oil as a surfactant pure water-vapor surface where σ=73-74 mN/m, releases the value of σ almost 1.8 fold to σ=39-43 mN/m. Another example is natural milk, in which the surface tension at the time of interface between the shell of the natural fat globule and the plasma of the emulsion of natural milk is extremely small and, according to available publications σ=1.12±0.06 mJ/m². These values are commensurable with the interface tension at a gas/liquid metal inter-f hase. The thickness of a surfactant monolayer that envelops, for example, the water/vapor phase interface is several nanometers (see thickness of the surfactant of FIG. 1). Since the PET is intended to bring about perturbation, deformation, decomposition and the subsequent restoration. The time scale of implementation of the PET principle can be estimated in several ways. First, the characteristic times of decomposition of the phase interface for hydrodynamic fragmentation of liquid or vapor/gas inclusions of a liquid system correspond to the period of natural oscillation frequency of the pertinent inclusion. Obviously, fragmentation is a resonance process and manifests itself, upon the natural frequency of the inclusions and the frequency of the applied perturbation. For example, the natural period of a 2 micron as bubble is 150 nanoseconds, whereas the natural frequency of a liquid particle of similar size is approximately 50 nanoseconds (that is, the fragmentation time corresponds to a sub-micro second or a nanosecond scale.

Secondly, it is possible to estimate the maximum time of coating an initially perfectly pure phase interface by a layer of surfactant (i.e., the time of formation and stabilization of a single structural element of the heterogeneous system.) The addition of a surfactant usually reduces the surface tension by the amount Δσ and accordingly reduces the surface energy by the amount ΔE. This reduction corresponds, in the absence of dissipation, to the kinetic energy of the motion of the surfactant molecules. The rate of propagation of a surfactant layer having thickness h=5 nm

V=(2Δσ/ph)^{0.5} (2)

At Δσ=25×10⁻³ mN/m and ρ=10³ kg/m³, V=100 m/sec, which is quite appreciable. The time needed for coating a suspended particle 1 μm in size is 31 nsec corresponding to the nanosecond range and close to the previously cited estimates of implementation of PET.

We shall now estimate the energy indices of elementary PET processes, for example, of the fragmentation of a spherical particle with initial radius Ro into two identical particles with radii R₁=Rₒ/2^{⅓}. The fragmentation energy corresponds to the increase in the total surface energy of the two resultant particles relative to the surface energy of the original particle, or

ΔE=δΔS=4πδR₀²(3√2−1)=0.26E₀ (3)

This amounts approximately to one quarter of the initial surface energy and, for example, at σ=50 mN/m where 2R₀=2 μm, ΔE=0.16×10⁻¹² J. Clearly, the value for ΔE is exceedingly small.

Obviously, this value applies to an ideal fragmentation into two particles without allowance for dissipation and for the threshold energy needed for decomposing the inclusions. In actual fragmentation of particles, for example, in vacuum homogenization of an emulsion of natural milk by means of PET employing a VG-5 vacuum homogenizer (rated at 15 kW, 1.39 kg/sec with solid phase content of 2.5% by weight) when the fat globule size is reduced from 2 to 1.5 μm, the integral energy spent for breaking up a single original particle was of the order of 0.05 nJ. This value exceeds more than 300 fold the fragmentation energy in the ideal version and belongs to the sub-nano-Joule range, which also points to the existence of nanoscale energy effects of the PET principle.

The embodiments of the present invention also include physical processes for the implementation of the PET principle. The PET principle can be implemented when utilizing different physical phenomena and processes, but primarily in the following thermophysical effects:

reducing or raising the pressure in the gas(vapor)-liquid medium;

adiabatic flashing;

hydraulic impact;

pressure or rarefaction shock wave;

shear stress;

local turbulence;

cavitation and supercavitation.

A reduction in the pressure of a dispersed liquid medium may induce intensive flashing of the volatile component of the system, for example, upon an abrupt reduction in pressure to a pressure below saturation point. The subsequent rise in pressure induces condensation of vapor of the previously flashed phase with all its associated dynamic and thermal effects: collapse of the bubbles, appearance of micro- and cumulative jets, hydraulic impacts of microstreams, abrupt rise in temperature, pressure and electrical potential in the epicenter of the vicinity of the collapsing bubble, etc. This process is most efficiently implemented periodically with repetition for each portion of the fluid being treated.

A particular case of the PET is constant reduction in the pressure of the medium, for example, by directing the flow into a rarefaction region, where the pressure is lower than the saturation pressure of a metastable fluid. The application can include discharging the high-pressure, high-temperature flow to the atmosphere or to a vacuum. The positive aspect of this method consists in the fact that it is continuous rather than intermittent. It is also possible to subject the fluid to a high pressure, instead of lowering the pressure. For example, bubbling of cold liquid at above atmospheric pressure by superheated steam, which is accompanied by high-rate condensation. This method also enhances the corresponding heat and mass transfer.

Another embodiment of the invention relates to implementing PET through hydraulic impact or the abrupt deceleration of the flow with its attendant effects (i.e., vortex generation, microturbulence, cavitation phenomena, shock waves, etc.) High-pressure and rarefaction shock waves arise, for example, upon a break in high-pressure piping “Lasg-of-Coolant Accident (LOCA), collapse of vapor cavities, in ultrasonic cavitation, or by applying an electric discharge or laser pulses. These provide high-intensity single or periodic dynamic and temperature effects on a stationary or flowing body of the working fluid.

High-intensity shear stresses are attained at low linear dimensions in fluid-discharge or flow devices such as in rotating or circular flows in small slots or narrow gaps, when fluid flows at high pressure through special valves, matrices or nozzles. This method of utilizing PET is most effective fox high-viscosity non-Newtonian fluids.

Flow turbulence is involved in all the methods of implementation of PET and controls the enhancement of dynamic and heat and mass transfer processes in heterogeneous system. These phenomena usually arise due to setting up of special flow patterns or are induced by local resistances or turbulence promoters.

Cavitation forms a special mode of flow turbulization. It arises at local or specially provided obstacles (the so-called hydrodynamic cavitation) upon application of high-power ultrasound or periodic laser beams. They result in high-intensity dynamic perturbation of the gas-liquid system.

Classification of the Technologies and Heat and Mass Transfer Equipment Needed for Implementing the Pet Principle

The PET principle serves as the basis for optimizing the utilization of energy in heat-engineering processes and creates a scientific basis for working out new energy (resource) conservation technologies and of equipment for implementing them. Table 1 was compiled in accordance with physical effects (operating conditions, or unit operations). Table 1 includes the distribution of heat and mass transfer PET technologies and the pertinent equipment for their effective implementation. Each shaded rectangle in the table indicates that the suggested technology is implemented by means of the corresponding device of one of the four classes of PET heat engineering. For example, the first technology listed—(mixing dispersed components) can be implemented effectively either by means of a vacuum emulsifier (vacuum technology), or by using a pulsed rotary device (rotary-pulse technology) or on the basis of a pulsator (pulse technology) or, finally, by means of cavitation technology (cavitator, supercavitator, cavitating disperser, etc.).

TABLE 1.1
Technology and Equipment of the PET Principle

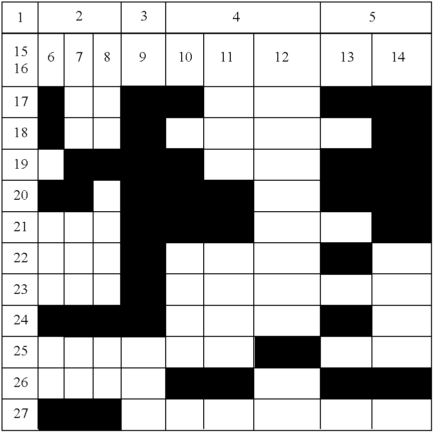

1) Technology class; 2) Vacuum Technology; 3) Rotary technology; 4) Pulsating technology; 5) Cavitation technology; 6) Vacuum emulsifier; 7) Vacuum homogenizer; 8) Vacuum degasifier; 9) Rotary-pulse device; 10) Pulsator; 11) Pulsed (intermittent-action) extractor; 12) Granulator; 13) Cavitator, supercavitator; 14) Disperser; 15) Equipment; 16) Technology; 17) Mixing; 18) Emulsifying; 19) Homogenization; 20) Mixing; 21) Extraction; 22) Dissolution; 23) Gasification; 24) Degasification; 25) Granulation; 26) Fragmentation (solid phase); 27) Concentration.

Characteristics of Pet Technologies

Mixing involves the formation of a coarse, but uniform liquid mixture of two or more components, including those that are mutually immiscible under standard conditions and under traditional methods. This technology is the most prevalent and precedes many of the other technologies in the first column of Table 1. Emulsification involves reducing the dispersed phase of the coarse mixture of mutually immiscible liquid components to the required mean size of the inclusion, as a rule, of the micron or submicron range. This technology is intended for obtaining emulsions or suspensions. Homogenization is carried out for subsequently breaking up the inclusions in the coarse emulsion into smaller particles and for producing a monodisperse homogeneous state of the dispersed phase with virtually identical shape and size of the particles. A homogenized emulsion has a picket-fence shape distribution of particle dimensions. The particles themselves have a “spike” shape.

The mixing technology consisting of extended maintenance of the state of macro-homogeneity is also extensively used. The traditional mixers which can provide macro and/or nanohomogeneity can be used. The mixing is carried out, as a rule, for single-phase or single-component but anisotropic systems, and secondly, it is used for large volumes of substance or for a substance with a characteristic feature, for example, high-viscosity, paste-like substances. Mixing is used in various technologies, for example, in solidification of liquid metal, in chemically reacting systems, structural liquid cements or mixtures.

Liquid extraction technologies consist of specifically directed extraction of a given constituent of a solid or liquid medium. This process includes preliminary mixing and fragmentation of the solid phase, or emulsification of dispersed liquid media and their mixing.

Dissolution involves reconstitution of powdery materials or granules in a liquid, i.e., mixing of powders with a liquid to attain a uniform homogeneous consistency.

Gasification consists in saturating a liquid by a foreign gas, including the dissolution of the latter, the so-called absorption process—dissolution and distribution of fine gas bubbles in a liquid. At high gas contents gasification leads to the formation of bubbly structures and stable foam systems. The opposite technology, that of degasification, consists in extracting gas dissolved in a fluid. The deodorization technology, consisting of extracting foreign odors from a fluid, is similar to the latter.

The granulation technology is comprised of forming solid or encapsulated liquid particles—granules or a given size and shape—from a disperse fluid.

The fragmentation of a solid within a liquid is a process for obtaining fine suspensions which comprise macro-uniform homogenized formations of very fine solid inclusions in a liquid. In PET technologies this process is effectively utilized in extracting solid plant raw materials and in producing drilling mud.

Concentration consists in extracting the dispersing component, i.e., the carrier phase, from the liquid system, rather than the dispersed component (as opposed to extraction). One of the methods of concentrating is the so-called evaporation which involves reducing the principal component by vaporizing it.

All the above PET technologies are implemented by means of several classes of equipment—vacuum, rotary-pulse, linear-pulse and cavitation. Vacuum technology is based on treating the fluid as it flows into a rarefied space or into a deep vacuum with induction of various effects of flashing of the superheated carrier fluid, condensing its vapor, inception of foam structures and cavitation effects. The vacuum emulsifier is intended for obtaining of multi-component emulsions of mutually immiscible liquids. In one embodiment of the invention, a system of water-oil can be used. In another embodiment of the invention , the vacuum homogenizer is used for homogenizing natural-milk emulsions. In yet another embodiment of the invention, the vacuum degasifier is used for degassing and deodorizing disperse systems, including high-viscosity fluids.

In still another embodiment of the invention, rotary-pulse equipment, absorbers, aerators and disintegrators are extensively used. This class of equipment utilizes the principle of imposition of high-frequency pulsations onto rotating or circular flows.

The Linear Pulse Equipment

Pulsators, intermittent-action extractors, granulators generate periodically sign-alternating fluid flows by applying low-frequency pulsations, Equipment that utilizes cavitation effects (cavitators and superavitators) operates by producing a hydrodynamic cavity in the fluid. Ultrasonic cavitation is used in various dispersers.

As noted, in the embodiments of the invention relating to vacuum equipment, the operation of vacuum equipment is based primarily on the adiabatic flashing. Periodic local flashing of the fluid also occurs in rotary-pulse and linear pulse equipment, i.e., pulse producing equipment with a rotating pulse producer and straighter line orifice. Formation of air- and vapor-filled cavities in cavitation equipment also occurs under adiabatic flow discharge conditions. For this reason adiabatic discharge and flashing of the working fluid is inherent to all the embodiments of the invention listed in Table 1 and comprises a basis for the operation of a given equipment. This circumstance is responsible for invention to disclose the basis of the PET principle in adiabatically flashing flows and in designing high-efficiency technologies of emulsification or homogenization of disperse systems. Thus, the physical basis of an embodiment of the invention resides in the adiabatic flashing of a metastable (unsteady) flow of one liquid or a multi-component disperse liquid system.

The Dynamics of the Vapor Bubble as the Working Element of Nanoscale Processes

The principal working element of the PET principle in adiabatic flashing of fluids consists of the vapor bubble in all of the manifestations of its dynamics: inception from the nucleus, rapid radial growth, oscillation of the surface and collapse, including the formation of a cumulative jet. We shall examine the results of the behavior of a single vapor bubble that arises within a continuous fluid. This problem was originally posed by Rayleigh

The Dynamics of a Single Vapor Bubble

The dynamics of a vapor within the fluid of its origin is described by a set of equations of fluid dynamics and heat and mass transfer. In particular, the motion of the viscous incompressible fluid directly at the phase interface (at liquid side), induced by compression or expansion of a spherical bubble, is defined by the Rayleigh-Lamb equation:

$$\frac{ⅆ {V}_{R}}{ⅆ τ} = ( {P}_{2} - {P}_{l} - 1 , 5 {ρ}_{l} {V}_{R}^{2} - 2 σ / R - 4 {μ}_{l} {V}_{R} ) / {ρ}_{l} R , \qquad ( 4 )$$

where R is the radius of the bubble. If the growth or compression of the bubble are accompanied by evaporation or condensation, the velocity dR/dT of the spherical interface is not identical to the radial velocity VR of the liquid about the interface and is given by the expression

dR/dτ=V_{R}+M_{K}/ρ₁ (5)

where M_{R} is the rate of interphase mass transfer. The expression for the variation in the temperature of the vapor within the bubble is

$$\frac{ⅆ {t}_{2}}{ⅆ τ} = \frac{3}{{ρ}_{2} {c}_{2} R} ( {q}_{R} - {M}_{R} {c}_{2} {t}_{2} - {P}_{2} \frac{ⅆ R}{ⅆ τ} ) , \qquad ( 6 )$$

where q_{R} is the heat transfer rate through the phase interface. The variation in the vapor density is given by the expression

$$\frac{ⅆ {ρ}_{2}}{ⅆ τ} = \frac{3}{R} ( {M}_{R} - {ρ}_{2} \frac{ⅆ R}{ⅆ τ} ) , \qquad ( 7 )$$

whereas the vapor pressure can be calculated from the Van-der-Waals equation.

Further, the heat and mass transfer of the bubble dynamics can be analyzed within the framework of the molecular-kinetic theory. For example, the rate of mass transfer through the boundary of the bubble in the course of phase transitions can be determined by the expression:

M_{R}=β[ρ_{S}U₂(t_{S})−ρ₂(t₂)] (8)

here the quantity U₂(t) is proportional to the mean thermal velocity of the gas molecules at the corresponding temperature:

$${U}_{2} ( t ) = {( \frac{ℛ t}{2 π M} )}^{0 , 3} . \qquad ( 9 )$$

The heat flux through the phase interface is calculated from an equation in general form

q_{R}=ρ₂U₂c₂(t_{S}−t₂)+M_{R}c₂tₛ (10)

Within the framework of the integral method of solution of unsteady-state heat conduction problem, we can write an equation for the heat flux through the phase interface in the form of a boundary condition

$${λ}_{1} ( {t}_{S} - {t}_{2} ) \cdot ( \frac{2}{δ} + \frac{1}{R} ) = - {M}_{R} ( {t}_{S} ) \cdot L ( {t}_{S} ) - {q}_{R} ( {t}_{S} ) , \qquad ( 11 )$$

where δ(τ) represents the thickness of the unsteady thermal layer in the liquid adjoining the bubble/liquid interface. The integral quantity of heat H₁ transferred to the liquid as a result of heat transfer with the bubble is related to δ(τ) as

H₁(τ)=[4πρ₁c₁(t_{S}−t₂)·(4R²δ+Rδ²)]/12 (12)

On the other hand, the heat balance for the liquid is

$$\frac{ⅆ {H}_{l}}{ⅆ τ} = - 4 π {R}^{2} [ {M}_{R} ( {t}_{S} ) L ( {t}_{S} ) + {q}_{R} ( {t}_{S} ) ] . \qquad ( 13 )$$

The last two equations allow determining the thickness δ of the thermal layer

$$δ = 2 R \{ {[ 1 + \frac{3 {H}_{l}}{4 π {R}^{3} {ρ}_{1} {c}_{1} ( {t}_{S} - {t}_{2} )} ]}^{0.5} - 1 \} . \qquad ( 14 )$$

The distribution of temperature in the liquid in the vicinity of a thermal layer with thickness δ can be specified in the form

$${t}_{2} ( r , τ ) = {t}_{2} + ( {t}_{S} - {T}_{2} ) {\frac{R ( τ )}{γ} [ \frac{R ( τ ) + δ ( τ ) - r}{δ ( τ )} ]}^{2} . \qquad ( 15 )$$

Equations (1.1)-(1.10) comprise the general set of equations of dynamics ox a single bubble. These equations must be supplemented by initial conditions, data on the variation in the thermophysical properties of the liquid (density, viscosity, surface tension, specific heat of vaporization), and also by the time dependence of the variation in the pressure above the liquid.

Results of Calculations of the Babble Model

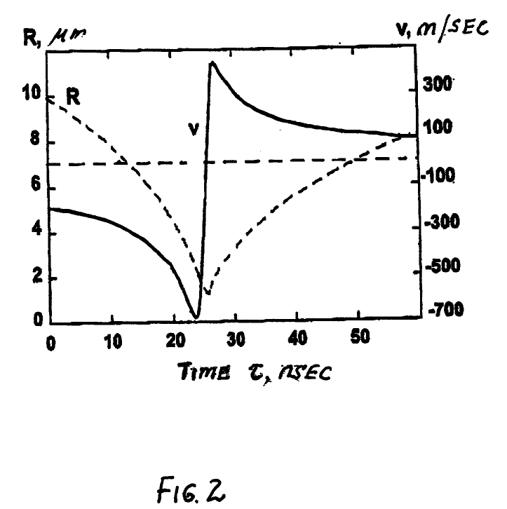

According to the principles of the invention, the following is the calculation results of a bubble dynamics based on the above-discussed model as shown in FIGS. 2-7. The vapor bubble arises within the liquid under the following conditions: a vapor bubble at temperature t_{2,0}=120° C. and defined by an initial radius R₀, which subsequently undergoes an oscillatory reduction in size (reduction in radius) and, in the end, collapses, becomes instantaneously a part of the ambient liquid (water) at temperature t_{1,0}=30° C. and at standard pressure.

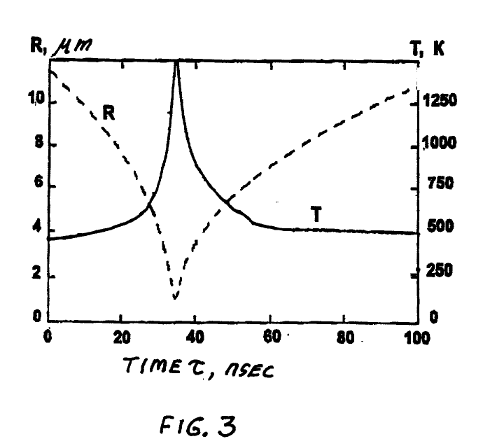

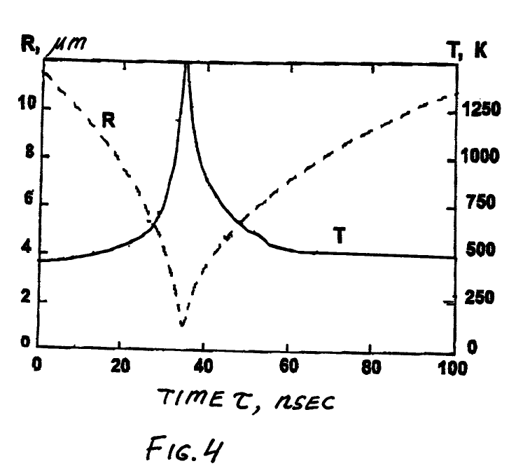

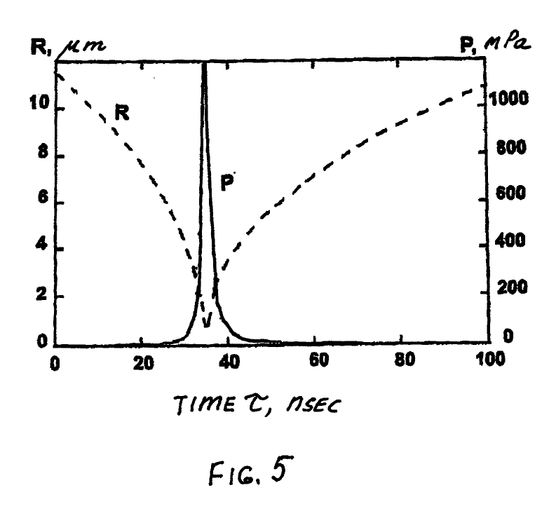

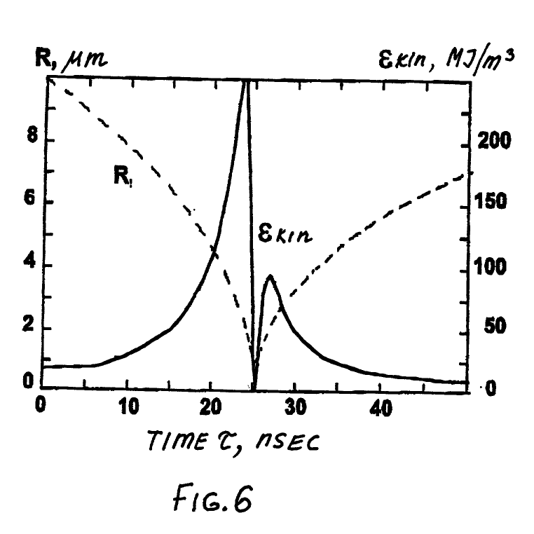

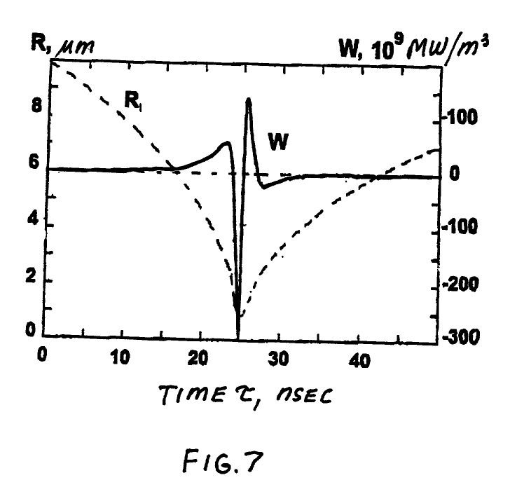

FIGS. 2 to 7 show the results of the variation in time of the parameters of the vapor-water system in the course of the first oscillatory period. Referring to FIG. 2, the dynamics of the bubble radius and of the radial rate of oscillations of the interphase (for R₀=10 μm) is shown. The behavior of the radius of the bubble is asymmetrical. That is, the rate of reduction in the radius is higher during the compression half period than the local growth of the bubble during the subsequent period. This means that the absolute rate of compression exceeds this rate at expansion (See FIG. 2). The velocities may be as high as 700 m/sec. which is quite appreciable. The attendant of phase interface are highest when the bubble radius is at minimum size and may attain values of 10¹⁰ m/sec (See FIG. 3) i.e., are equal to billion-fold the acceleration due to due to gravity. When phases change, their velocities change with attendant acceleration. The vapor temperature within the bubble is at maximum when the pulsating radius is at minimum (See FIG. 4). The high temperature is caused by the concentration of the kinetic energy of the interface on the bubble and may amount to more than 1500° C. during the first half period. Under these conditions the instantaneous vapor pressure rises during 1-5 nanosececonds to approximately 12 thousand atmospheres (See FIG. 5). The specific kinetic energy of a collapsing bubble at the points in time where the radius is at minimum exhibits two peaks (See FIG. 6), attaining a limiting value in excess of 300 J/cm³, whereas the specific density of kinetic energy of the compressed bubble (See FIG. 7) increases to 100-300 MW/mm³.

It follows from model calculations that the amplitude of radius fluctuations of a collapsing vapor bubble decreases at each successive oscillatory period at a rate of between 20 to several percent. The amplitude of velocity fluctuations during the subsequent periods increases approximately 1.3-1.5 fold, whereas the rise in the amplitude of acceleration of the phase interface is about 10%. The specific rate of generation of the subsequent oscillations increases 1.5 fold on the average. It is seen from FIG. 6 that the instantaneous energy density at the phase interface over a period of 5 nsec exceeds 100 MJ/m³, which is several-fold higher than the energy of dissociation of water. This means, in particular, that the energy of collapse of a vapor bubble is sufficient for breaking up molecules 0.3 to 1 nm in size in the boundary layer, which, in its turn, is the physical prerequisite for catalytic effect of complex chemical reactions, sonoluminescence , activation of working systems, superfine emulsification and similar phenomena.

Nanoscale Effects in Heterogeneous Liquid Systems

Investigations of the dynamics of collapsing bubbles in liquid systems showed that the high temperatures and pressures that arise at the final stages of collapse, act within 0.1 to 1 msec and that the rate of rise, for example, in the temperature is of the order of 10¹⁰-10¹² K/sec. Analysis of the behavior of real gas-liquid systems at such rates of variation in thermodynamic parameters is extremely difficult and involves a number of cardinal difficulties. For example, taking into account the fact that the parameters of vapor-gas mixture in the vicinity of a bubble under compression attain supercritical values (for water p_{cr}=21.83 MPa, T_{cr}=647.4 K), then it must be assume that the gas-liquid interface vanishes. Large-scale density fluctuations and other physical phenomena become quite probable under supercritical conditions.

It should not be expected that ultrasonic-frequency mechanical oscillations cause breaking of the molecular bonds of liquids. The oscillatory frequencies of atoms within a fluid molecule exceed by many orders of magnitude the frequencies of acoustic oscillations (for example, the frequency of deformation oscillations of the water molecule is 4.9×10¹³ Hz) thereby making resonance impossible. Still, excitation and ionization of molecules should occur to a large extent within the bubble as it attains its minimum radius. The laws of quantum mechanics impose serious limitations on the probability of attainment of different states of the particles and on their mutual transitions. The concept of temperature has a definite meaning only in the case of complete thermodynamic equilibrium of the system. Bubble collapse is an irreversible process and the rate of variation in temperature T at the last stage of collapse may represent the degree of deviation of the gas from equilibrium. The molecules of gases and liquid present in the bubble possess a certain energy corresponding to their translational motion, rotational motion, intramolecular fluctuations and electron excitation. Only a relatively small number of collisions is needed for attaining the Maxwellian distribution of molecule velocities and the system can then be described by a certain, effective translational temperature. For at least this reason molecular collisions cause transition of kinetic energy to the energy of excitation, the ionization energy.

The total energy of a molecule in the first approximation, at moderate values of quantum numbers, can be represented as a sum of the energies of translational motion and the energy of the internal degrees of freedom:

ε=ε _{nocm} [symbol]+εᵤₚ+ε [symbol] ε+ [symbol] (16)

The energy of translational motion of a molecule can be determined by

ε _{nocm} [symbol]=mν²/2 (17)

where m is the mass is the mass of the molecule and ν is its velocity. The energy of rotational motion for the elementary case of a diatomic molecule can be determined by:

$${ϵ}_{up} = \frac{{h}^{2}}{2 {π}^{2} J} \cdot j \cdot ( j + 1 ) , \qquad ( 18 )$$

where J is the moment of inertia of the molecule and j (j=0, 1, 2, . . . ) is the rotational quantum number. According to selection rules, the only transitions possible are those at 4j=0 or ±1.

The vibrational energy of a molecule for not too high levels, when the oscillations can be regarded as harmonic, can be described by

$${ϵ}_{KOR} = Σ h \cdot {v}_{i} \cdot ( {ϑ}_{i} + \frac{1}{2} ) , \qquad ( 19 )$$

where νᵢ are the oscillatory frequencies of the atoms whereas lᵢ is the vibrational quantum number equal to 0, 1, 2, . . .

The intervals between the vibrational levels decrease with increasing levels, however, they may be much larger than the intervals between the rotational levels. While not wishing to be bound to any theory, it is believed that vibrational transitions usually occur at temperatures on the order of thousands of degrees.

The main energy content of the molecule and the energy state—the therm—can be determined by its electron state and is defined by the quantized magnitude of the projection of the electron momentum Λ onto the axis of symmetry; Λ can be equal to 0, ±1, ±2, . . . Corresponding to these numbers that define Λ, the electron level is designated by Σ, Π, Δ, etc. The difference in energy corresponding to the different states of electrons in the molecule can be of the same order of magnitude as in atoms (i.e., several electron-volts in the lower states).

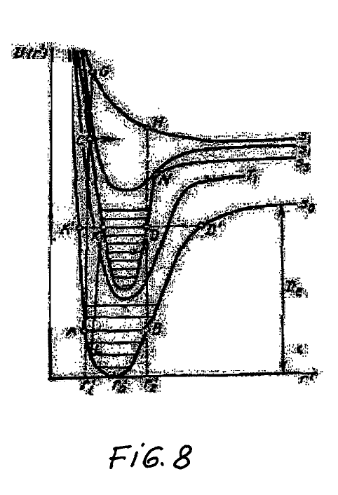

If the number of electrons in a molecule is odd, then the resulting spin S is equal to one of the numbers: ½, 3/2, 5/2, . . . , and if it is even, then S can be equal to one of the numbers: 0, 1, 2, etc. Depending on the values of S (S=0, ½, 1, . . .), electron levels are termed as singlet, doublet, triplet, etc., whereas multiplicity, equal to (2S+1), is designated by the applicable numeral to the left in the top corner of the symbol of the therm (for example, ¹Σ, ¹Π, ³Δ, etc.). Each electron level in FIG. 8 corresponds to a curve of the potential energy U(r′) as a function of interatomic distance r′. Here, the equilibrium value r′=r₀′ has corresponding to it the minimum of potential energy and when r′ increases appreciably, U(r) becomes equal to the energy Dₑ of dissociation of the molecule (See FIG. 8). The potential energy curve of a diatomic molecule can be calculated from the Morse formula:

$$U ( {r}^{′} ) = {{D}_{e} [ 1 - exp ( - {α}_{n} \frac{{r}^{′} - {r}_{0}^{′}}{{r}_{0}^{′}} ) ]}^{2} , \qquad ( 20 )$$

where α_{osc} is a function of the oscillatory frequency and other parameters of the molecule.

The vibratory energy levels (horizontal lines in FIG. 8) are plotted onto the graph of U(r′); the ordinates of points of these lines correspond to the sum of the potential and kinetic energies of the oscillating atoms. At coordinates r′₁and r′₂ in points A and B, that correspond to intersection between the vibratory levels and the potential energy curve, all this energy is equal to the potential energy (turning points) and their instantaneous velocity is equal to zero. Hence the time of residence of atoms in these points is at maximum and the transition to the higher energy level that is described by curve s₁, most likely occurs from these turning points. In keeping with the Franck-Condon principle, electronic transition is a rapid process (approximately 10⁻¹⁵ sec) as compared with the oscillatory motion of the nuclei (approximately 10⁻¹² sec). Hence, the nuclei can be regarded as stationary in the course of an electron transition. For this reason the vertical transitions: AC, AG, BD, etc., are the most likely. The time of dissociation of a molecule in the course of electron transition from point A to point C is much smaller than the oscillatory period, and a rather stable excited molecule forms upon transition BD. This molecule inevitably dissociates upon transition onto repulsion curve s₂ (AU or BH) (See FIG. 8).

The degree of ionization of a gas at moderate temperatures (of the order of several thousand degrees), when secondary ionization can be neglected, can be calculated from the Saha formula:

$$\frac{{α}_{1}^{2}}{1 - {α}_{1}} = \frac{u}{{u}_{0}} \frac{2 {M}_{Γ}}{{ρ}_{Γ} {N}_{A}} {( \frac{2 π {m}_{e} {k}_{B} T}{{h}^{2}} )}^{3 / 2} exp ( \frac{{I}_{H}^{′}}{{k}_{B} T} ) , \qquad ( 21 )$$

where u and u₀, are the statistical electron sums, mₑ is the electron mass, M_{g} is the molecular weight of the gas, ρ_{g} is its density and I′ᵢₒₙ is the ionization potential of the gas.

$${α}_{1} \sim {ρ}_{Γ}^{- 1 / 2} exp ( - \frac{{I}_{H}^{′}}{2 {k}_{B} T} ) \qquad ( 22 )$$

At I′ᵢₒₙ>>k_{B} and α<<1 the degree of ionization usually increases very rapidly with the temperature and decreases slowly with increasing pressure of the gas. However, the ionization values actually observed frequently exceed the predicted values by a great margin. For monatomic inert gases up to temperatures of the order of 8000° K. when, according to the Saha equation, ionization becomes perceptible, the specific heat, naturally is unable to increase on account of dissociation and hence the rise in temperature in a cavity should be much more effective than in the presence of polyatomic gases. In the course of ionization of particles with close masses the kinetic energy of the impacting particle should be approximately two-fold higher than the ionization potential. For example, atsₒₛₜ=100 eV each Ar atom ionizes on the average two Ar atoms, an Ne atom—about 0.1 of an Ne atom, and the He atom—less than 0.01 of the He atom. This is caused not only by reduction in the mass of the particles, but also by the increase of the ionization potential in the series: Ar, Ne, He.

The probability of electron excitation upon collisions increases with the temperature, since the average thermal velocity ν˜T^{½}. The effectiveness of energy transfer by Franck-Hertz collisions of the first or second kind is determined by the relative velocity ν of the colliding particles and the magnitude Δs of the inelastic collision energy being transferred. In general, the calculation of the probability of transition and of the effective collision cross section is complicated and not readily discernable. If the collision time d′/ν (where d′ is the characteristic dimension of the “quasimolecule” that forms upon the collision) is appreciably greater than the time h/ΔE of transfer of energy from the colliding particle, one may apply the adiabatic theory of perturbations. According to the Massey criterion the maximum limiting velocity of a particle that excites vibrational energy by is equal to

ν ₙₚ [symbol]˜2πνd′ (23)

The same situation is observed upon transfer of energy Os or upon recharging:

$${υ}_{n p} \sim \frac{Δϵ}{h} {d}^{′} \qquad ( 24 )$$

When conditions (5) and (6) are satisfied the probability and the effective cross section of transition decrease exponentially with reduction in the relative velocity of the colliding particle (proportionally to ˜exp (-const/ν) . Charge transfer (recharging) is to a large extent similar to the transfer of excitation. The dependence on ν of the effective cross section of transition upon collision of fast particles, when ν>>νₗᵢₘ may turn out to be quite complex. Resonant symmetrical recharging or the transfer of excitation energy between molecules of the same kind are of particular interest.

Since the initial ion or excited states are the same (i.e., ΔE=0), the probability of their occurrence is at a maximum. Although these processes do not induce chemical changes in the system, the sequential transfer of excitation to neighboring molecules of the same kind causes the excited particle to change its location and, in the final analysis, increases the observed “lifetime” of the excited state.

The molecular activation mechanisms described above can increase the rate of chemical transformations in heterogeneous fluids with dispersed solids. Since the bubble originates in the first place at the phase interface, where the principal resistance is indeed concentrated, the subsequent bubble collapse highly intensifies the transfer processes. In fact, the molecular flux J_{M} is related to the mean free path A_{M} and the Knudsen accommodation coefficient a by the expression:

$${J}_{M} \approx \frac{n {U}_{T}}{\frac{δ}{{Λ}_{M}} + \frac{1}{α}} , \qquad ( 25 )$$

where n is the concentration of molecules, U_{T} is their thermal velocity and δ is the thickness of the diffusion film. An increase in δ and in U_{T} brings about a rise in Jₘ.

The following examples indicate the physico-chemical effects of the invention. We shall now enumerate the principal physical (more precisely physico-chemical) effects that accompany the chemical intensifying action of collapsing bubbles.

### EXAMPLE I

### Degasifcation of Liquids, Which Can be Observed Visually

The liquid located at a large distance from a fluctuating LDB (large deformed bubble) is transparent, but at a distance of ˜4 cm from an LDB one can see a “cloud” of small bubbles which gradually increase in size and move toward the LDB driven by the Bjerkness force. The rate of degasification increases with increasing oscillatory amplitude and the process comes to a completion virtually in several minutes.

### EXAMPLE II

Emulsification is best observed and investigated by photography and high-speed filming in water to which a small quantity of iodine-tinted CCl₄ is added. The CCl₄, was located at the bottom of the test tube and did not deform in the course of formation of the LDB, of the latter's growth and fluctuations in the upper part of the test tube beneath the piston. When the LDB was moved to the bottom of the test tube (by changing the power or the frequency), the pulsatile fluxes of liquid generated by the LDB impacted on the layer of CCl₄, penetrated it and left it, having entrained droplets of CCl₄ which gradually settled, but did not join the bulk of the CCl₄, and an emulsion was obtained. Another emulsification mechanism was observed at a lower oscillatory amplitude: the surface of the CCl₄, was pulled toward the LDB with attendant formation of surface waves and breakoff of fine particles of the heavier liquid.

Emulsification proceeded in the most effective manner when the LDB moved into the layer of the CCl₄. The rapidly deforming “protuberances” and other projections that formed on the surface of the LDB ejected fine CCl₄, droplets into water.

### EXAMPLE III

Emulsification is accompanied by another, clearly observed process: attraction of the nascent emulsion droplets to the LDB. This coalescence of droplets at the LDB surface may possibly explain the attainment of the steady state in emulsification, and also the breakup of emulsions in an ultrasonic field under certain conditions (frequency, intensity, field configuration, etc.).

Dispersion was induced following the formation of the LDB. Coal granules moved toward the LDB and then, entrained by pulsatory flows, impacted with force on the test-tube wall, forming intricately-shaped closed trajectories. This process was repeated after the granules were attracted to the LDB. When impacting on the test-tube, walls the granules became fragmented and these fragments also participated in the above process. This activity gradually transformed the granules into powdered coal, meaning, caused dispersion. It can be assumed that to some extent mutual collisions of particles and their impacting on the solid surface play a certain role in the course of dispersion also at high sonic and ultrasonic velocities.

Erosion at low sonic frequencies can occur in a unique manner. Two effects were observed, both associated with the effect on the LDB on solid surfaces. An aluminum-foil specimen was attracted by the LDB and performed chaotic motions about it. It is known that a bubble and a solid surface exert mutual attraction. The attraction of the foil to the LDB is caused by the same kind of interaction. Since the “effective mass” of a fluctuating bubble is appreciably larger than the mass of the foil or of coal granules, the latter are attracted to the LDB. The interaction between the interface of two liquids and the LDB can be explained similarly (see emulsification). In certain cases the LDB embraced the foil from both sides in such a manner that the foil separated the bubble into two parts. The activity of the LDB produced through, intricately shaped cracks in the foil; the length and width of these cracks gradually increased with the exposure.

The erosion of solids at low acoustic frequencies also exhibits unique features: whereas the high frequencies the erosion is of the surface type, resulting in the formation of a rough surface that displays the traces of crumbling out of rather large particles, at flow frequencies the surface is smoothed out and almost polished, most likely as a result of crumbling out of microscopic particles.

Surface smoothing in a low-frequency acoustic held as well as the other aforementioned physiochemical effects occurred only by virtue of the LDB effect. Small spherical bubbles did not participate in these processes.

Surface erosion and dispersion of solids. At present ultrasound is extensively used in dispersing solids and in improving surface smoothness. Erosion of solids caused by collapsing bubbles is similar to these processes. Since each of these processes involves breaking crystal lattice bonds, they can be analyzed together.

It has been suggested that the erosion effectiveness of acoustic energy associated with the energy of shock waves formed by cavitating bubble be assessed on the basis of the concept of acoustic erosion efficiency:

η ₛₚ [symbol]=E_{M}/E (26)

where E_{M} is the energy spent for mechanical erosion decomposition. Quantity ηₑᵣ can be written as the product of two quantities:

$${η}_{sp} = {χϵ}_{M} \frac{{E}_{M}}{E} \frac{{E}_{M}}{{E}_{M}} \qquad ( 27 )$$

where ε_{M}, is the coefficient of mechanical activity of cavitation. Up to recently it was unclear how to define E_{M} It was suggested that it be calculated in the following manner. In the final analysis, E_{M} is spent for rupturing metal-metal bonds in the course of erosion tests with a metal specimen and for rupturing chemical bonds in the crystal lattice when dispersing solids.

The local rate of mechanical cavitation decomposition for an inhomogeneous acoustic field is written as:

$${w}_{M} = \frac{{\partial }^{2} Δ G}{\partial V \partial t} , \qquad ( 28 )$$

where ΔG is the total mass of the solid particles which are separated from the specimen in the course of erosion or dispersion. Knowing the additional surface Δs that forms as a result of cavitation decomposition, it is possible to calculate the number of the ruptured bonds and, as a result, the energy E_{M}:

$${E}_{M} = \frac{Δ s {q}_{0}}{2 {d}_{T}^{2} {N}_{A}} \qquad ( 29 )$$

where q, is the energy of bond rupture (per 1 mole of substance) and d, is the kinetic diameter of the molecule.

Dispersion of solids involves a perceptible increase in the surface area (s>>s₀) and hence in the majority of cases one may neglect the original surface area (s₀) as compared with the final area (s) and assume that Δs=s. Since the currently used methods do not allow determining s and, consequently, E_{M}, they can be regarded only as qualitative methods of assessing the erosion activity. When using a metal specimen it is possible to determine As experimentally (for example, by adsorption, microscopic and other methods). However, nothing concerning such measurements has been published and hence currently there is insufficient experimental data for determining acoustic-erosion or mechanical-erosion efficiency and it is only possible to analytically relate Δs and ΔG by specifying an average radius r (average radius) for the dispersed particle.

Obviously,

$$Δ G = {ρ}_{T} {\sum }_{i = l}^{{n}_{r}} \frac{4}{3} π {r}_{l}^{3} = {ρ}_{T} {n}_{T} \frac{4}{3} ( π {\overline{r}}^{3} ) \qquad ( 30 )$$

where n, is the number of formed particles and ρ_{T} is the density of the solid material. Since the acoustic-erosion or mechanical-erosion) efficiency for the heterogeneous cavitated region is equal to the product:

$${χϵ}_{M} = \frac{\frac{{\partial }^{2} {E}_{M}}{\partial V \partial t}}{\frac{{\partial }^{2} E}{\partial V \partial t}} , \qquad ( 31 )$$

Upon substituting E_{M}, we obtain:

$${χϵ}_{M} = \frac{{q}_{0}}{2 {N}_{A} {d}_{T}^{2}} \frac{{\partial }^{2} s}{\partial V \partial t} / \frac{{\partial }^{2} E}{\partial V \partial t} . \qquad ( 32 )$$

By substitute into this expression Δs=3ΔG/(ρₛr)

$${χϵ}_{M} = \frac{3 {q}_{0}}{2 {ρ}_{T} \overline{r} {N}_{A} {d}_{T}^{2}} \frac{{\partial }^{2} Δ G}{\partial V \partial t} / \frac{{\partial }^{2} E}{\partial V \partial t} . \qquad ( 33 )$$

Upon substitution of the previously presented expressions, we obtain the following expression for the rate of mechanical cavitation decomposition:

$${w}_{M} = \frac{2 {ρ}_{T} \overline{r} {N}_{A} {d}_{T}^{2}}{3 {q}_{0}} {χϵ}_{M} \frac{{\partial }^{2} E}{\partial V \partial t} . \qquad ( 34 )$$

The above shows that, in order to investigate the energetics of erosion, dispersion and others, it is necessary to measure the newly formed surface area Δs rather than the reduction in the mass of the specimen, as was done in all the published studies.

Emulsification of Liquids

As in the case of cavitation erosion, the acoustic emulsion coefficient will be written as the product of two quantities:

$${η}_{e M} = {χϵ}_{M} = \frac{{E}_{x}}{E} \frac{{E}_{e M}}{{E}_{M}} = \frac{{E}_{e M}}{E} , \qquad ( 35 )$$

where ε_{cm} is the cavitation effectiveness coefficient in the course of emulsifying and E_{M} is the energy spend for obtaining the emulsion. As for dispersion, The rate of emulsification can be defined as:

$${w}_{e M} = \frac{{\partial }^{2} Δ {G}_{e M}}{\partial V \partial t} \qquad ( 36 )$$

where ΔGₑₘ is the total mass of particles of an emulsion of a certain type (the formation of the so-called inverse emulsions for binary and more complex mixtures does not involve principal changes).

Further, depending on the conditions (frequency, strength of acoustic oscillations, concentration of constituents, temperature, surfactant addition, etc.) one usually obtains a certain limiting concentration of the disperse phase, at which the emulsification and coalescence rates become equal. Since the rate of the process changes highly with time, wₑₘ at the initial time and at low exposure which must be sufficiently large as compared with the time of attainment of the steady-state quantity of cavitation bubbles in the ultrasonic field. The energy spent for formation of the emulsion can be defined by:

[symbol]

Eₑₘ=∫ₛ∫(σ₁−σ₂)ds (37)

where s is the interface between two immiscible liquids, σ₁ and σ₂ are the surface tensions of these liquids at their interface with air. The surface tension at the liquid-liquid interface is (σ₁-σ₂). After the emulsion droplet size distribution is determined experimentally, E_{M} can be calculated as:

$${E}_{e m} = {\sum }_{E = 1}^{{E}_{e m}} 4 π {r}_{1}^{2} ( {σ}_{1} - {σ}_{2} ) = 4 π {r}^{- 2} {n}_{l} ( {σ}_{1} - {σ}_{2} ) \qquad ( 38 )$$

where n₁ is the number of droplets in the emulsion and r is the average droplet radius. Since ΔGₑₘ=ρlnl(4/3)πr and s>>s₀:

[symbol]

Δs =4πη₇πvₗ²=3ΔG∫^{em} (39)

In the heterogeneous cavitation region:

$$χϵ {\int }_{3 m}^{e m} = \frac{3 ( {σ}_{1} - {σ}_{2} ) {\partial }^{2} Δ G {\int }_{3 m}^{e m} {\partial }^{2} Δ E}{{l}_{l}^{v} d \partial V \partial T \partial V \partial T} \qquad ( 40 )$$

The rate of emulsification can be found:

$${ω}_{e m} = [ \frac{{l}_{l} r}{3 ( {σ}_{1} - {σ}_{2} )} ] ( {χϵ}_{e m} ) [ \frac{{\partial }^{2} E}{\partial V \partial t} ] \qquad ( 41 )$$

What is claimed is:

1. A method for processing a substantially heterogeneous composition to a substantially homogenous solution comprising:
providing a heterogeneous medium having an interface surface region; and
applying energy to the interface region of the heterogeneous medium.

2. The method of claim 1, wherein the energy is applied to the interface of the heterogeneous surface in the form of a short pulse.

3. The method of claim 1, further comprising introducing energy directly to the interface region.

4. The method of claim 1, wherein the energy is supplied to each interface point in the solution.

5. The method of claim 1, wherein the energy is formed through pressure drop.

6. The method of claim 1, wherein the energy is in the form of shearing stress supplied to the interface region.

7. The method of claim 1, wherein the energy is supplied by bringing the inter-phase region to an adiabatic boil.

8. The method of claim 1, wherein the energy is supplied to the interface region is in the form of hydraulic energy.

9. The method of claim 8, wherein the hydraulic energy is supplied by a hydraulic hammer.

10. The method of claim 1, wherein the energy is supplied to the inter-phase region in the form of an electromagnetic wave.

11. The method of claim 1, wherein the electromagnetic wave is a blast wave.

12. A process for providing a substantially homogenized composition from a substantially heterogeneous composition comprising:
providing a heterogeneous composition having an interface surface;
supplying energy in the form of short pulses to the interface surface.
